(19) United States
(12) Patent Application Publication
(10) Pub. No.: US 2017/0197196 A1
(43) Pub. Date: Jul. 13, 2017

(54) EXCHANGER AND/OR REACTOR-EXCHANGER MANUFACTURED IN AN ADDITIVE PROCESS

(71) Applicant: L'Air Liquide, Societe Anonyme pour l'Etude et l'Exploitation des Procedes Georges Claude, Paris (FR)

(72) Inventors: Pascal DEL-GALLO, DOURDAN (FR); Olivier DUBET, Buc (FR); Laurent FROST, Gif Sur Yvette (FR); Marc WAGNER, Saint Maur des Fosses (FR); Matthieu FLIN, Paris (FR)

(73) Assignee: L'Air Liquide, Societe Anonyme pour l'Etude et l'Exploitation des Procedes Georges Claude, Paris (FR)

(21) Appl. No.: 15/324,843

(22) PCT Filed: Jun. 30, 2015
(86) PCT No.: PCT/FR2015/051784

§ 371 Date: Jan. 9, 2017

(30) Foreign Application Priority Data
Jul. 9, 2014 (FR) 1456623

(51) Int. Cl. B01J 19/24; F28D 9/00; F28F 3/12; B01J 19/00

(52) U.S. Cl. CPC B01J 19/249; B01J 19/0013; F28D 9/0081; F28F 3/12; B01J 2219/00076; B01J 2219/2462; B01J 2219/2492; F28D 2021/0022

(57) ABSTRACT

Disclosed is a reactor-exchanger or an exchanger comprising at least 3 levels, each of which includes at least one region with millimeter channels promoting heat exchange and at least one distribution region upstream and/or downstream of the region with millimeter channels, characterized in that the reactor-exchanger or exchanger is a unit that has no mounting interfaces between the various levels.

### CROSS-REFERENCE TO RELATED APPLICATIONS

This application is a §371 of International PCT Application PCT/FR2015/051784, filed Jun. 30, 2015, which claims §119(a) foreign priority to French patent application FR 1456623, filed Jul. 9, 2014.

### BACKGROUND

Field of the Invention

The present invention relates to exchanger-reactors and to exchangers and to the method of manufacturing same.

More specifically, it concerns millistructured exchanger-reactors and exchangers used in industrial processes that require such apparatus to operate under the following conditions:

(i)—a high temperature/pressure pair,

(ii)—minimal pressure drops and

(iii)—conditions that allow the process to be intensified, such as the use of a catalytic exchanger-reactor for the production of syngas or the use of a compact plate type heat exchanger for preheating oxygen used in the context of an oxy-combustion process.

Related Art

A millistructured reactor-exchanger is a chemical reactor in which the exchanges of matter and of heat are intensified by a geometry of channels of which the characteristic dimensions such as the hydraulic diameter are of the order of one millimeter. The channels that make up the geometry of these millistructured reactor-exchangers are generally etched onto plates which are assembled with one another and each of which constitutes one stage of the apparatus. The multiple channels that make up one and the same plate are generally connected to one another and passages are arranged in order to allow the fluid (gaseous or liquid phase) employed to be transferred from one plate to another.

Millistructured reactor-exchangers are fed with reagents by a distributor or a distribution zone one of the roles of which is to ensure uniform distribution of the reagents to all the channels. The product of the reaction carried out in the millistructured reactor-exchanger is collected by a collector that allows it to be carried out of the apparatus.

Hereinafter the following definitions shall apply:

(i)—“stage”: a collection of channels positioned on one and the same level and in which a chemical reaction or an exchange of heat occurs,

(ii)—“wall”: a partition separating two consecutive channels arranged on one and the same stage,

(iii)—“distributor” or “distribution zone”: a volume connected to a set of channels and arranged on one and the same stage and in which reagents conveyed from outside the reactor-exchanger circulate toward a set of channels, and

(iv)—“collector”: a volume connected to a set of channels and arranged on one and the same stage and in which the products of the reaction carried from the set of channels toward the outside of the reactor-exchanger circulate.

Some of the channels that make up the reactor-exchanger may be filled with solid shapes, for example foams, with a view to improving the exchanges, and/or with catalysts in solid form or in the form of a deposit covering the walls of the channels and the elements with which the channels may be filled, such as the walls of the foams.

By analogy with a millistructured reactor-exchanger, a millistructured exchanger is an exchanger the characteristics of which are similar to those of a millistructured reactor-exchanger and for which the elements defined hereinabove such as (i) the “stages”, (ii) the “walls”, (iii) the “distributors” or the “distribution zones” and (iv) the “collectors” are again found. The channels of the millistructured exchangers may likewise be filled with solid forms such as foams, with a view to improving exchanges of heat.

Thermal integration of such apparatus may be the subject of far-ranging optimizations making it possible to optimize the exchanges of heat between the fluids circulating through the apparatus at various temperatures thanks to a spatial distribution of the fluids over several stages and the use of several distributors and collectors. For example, the millistructured exchangers proposed for preheating oxygen in a glass furnace are made up of a multitude of millimeter-scale passages arranged on various stages and which are formed using channels connected to one another. The channels may be supplied with hot fluids for example at a temperature of between approximately 700° C. and 950° C. by one or more distributors, The fluids cooled and heated are conveyed outside the apparatus by one or more collectors.

In order to take full advantage of the use of a millistructured reactor-exchanger or of a millistructured exchanger in the target industrial processes, such equipment needs to have the following properties:
it needs to be able to operate at a “pressure x temperature” product that is high, generally greater than or equal to approximately of the order of 12×10⁸ Pa.° C. (12 000 bar.° C.), which corresponds to a temperature greater than or equal to 600° C. and a pressure at greater than 20×10⁵ Pa (20 bar);
they need to be characterized by a surface area-to-volume ratio less than or equal to approximately 40 000 m²/m³ and greater than or equal to approximately 4000 m²/m³ in order to allow the intensification of the phenomena at the walls and, in particular, the heat transfer;
they need to allow an approach temperature less than 5° C. between the inlet of the hot fluids and the outlet of the cooled or warmed fluids; and
they need to induce pressure drops less than 10⁴ Pa (100 mbar) between the distributor and the collector of a network of channels transporting the same fluid.

Several equipment manufacturers offer millistructured reactor-exchangers and exchangers, Most of these pieces of apparatus are made up of plates consisting of channels which are obtained by spray etching. This method of manufacture leads to the creation of channels the cross section of which has a shape approaching that of a semicircle and the dimensions of which are approximate and not exactly repeatable from one manufacturing batch to another because of the machining process itself. Specifically, during the etching operation, the bath used becomes contaminated with the metallic particles removed from the plates and although the bath is regenerated, it is impossible, for reasons of operating cost, to maintain the same efficiency when manufacturing a large production run of plates. Hereinafter a “semicircular cross section” will be understood to mean the cross section of a channel the properties of which suffer from the dimensional limitations described hereinabove and induced by the manufacturing methods such as chemical etching and die stamping.

Even though this method of channel manufacture is not attractive from an economical standpoint, it is conceivable for the channels that make up the plates to be manufactured by traditional machining methods. In that case, the cross section of these channels would not be of semicircular type but would be rectangular, these then being referred to as having a “rectangular cross section”.

By analogy, these methods of manufacture may also be used for the manufacture of the distribution zone or of the collector, thereby conferring upon them geometric priorities analogous to those of the channels, such as:

(i)—the creation of a radius between the bottom of the channel and the walls thereof in the case of manufacture by chemical etching or die stamping and of dimensions are not repeatable from one manufacturing batch to another, or alternatively

(ii)—the creation of a right angle in the case of manufacture using traditional machining methods.

The plates thus obtained, made up of channels of semicircular cross section or cross section involving right angles, are generally assembled with one another by diffusion bonding or by diffusion brazing.

The sizing of these pieces of apparatus of semicircular or rectangular cross section is reliant on the application of ASME (American Society of Mechanical Engineers) section VIII div.1 appendix 13.9 which incorporates the mechanical design of a millistructured exchanger and/or of a reactor-exchanger made up of etched plates. The values to be defined in order to obtain the desired mechanical integrity are indicated in FIG. 1. The dimensions of the distribution zone and of the collector are determined by finite element calculation because the ASME code does not provide analytical dimensionings for these zones.

Once the dimensions have been established, the regulatory validation of the design, defined by this method, requires a burst test in accordance with ASME UG 101. For example, the expected burst value for a reactor-exchanger assembled by diffusion brazing and made of inconel (HR 120) alloy operating at 25 bar and at 900° C. is of the order of 3500 bar at ambient temperature. This is highly penalizing because this test requires the reactor to be over-engineered in order to conform to the burst test, the reactor thus losing compactness and efficiency in terms of heat transfer as a result in the increase in channel wall thickness.

At the present time, the manufacture of these millistructured reactor-exchangers and/or exchangers is performed according to the seven steps described in FIG. 2. Of these steps, four are critical because they may lead to problems of noncompliance the only possible outcome of which is the scrapping of the exchanger or reactor-exchanger or, if this noncompliance is detected sufficiently early on on the production line manufacturing this equipment, the scrapping of the plates that make up the pressure equipment.

These four steps are:
the chemical etching of the channels,
the assembly of the etched plates by diffusion brazing or diffusion bonding,
the welding of the connection heads, on which welded tubes supply or remove the fluids, onto the distribution zones and the collectors, and finally
the operations of applying a protective coat and/or a layer of catalyst in the case of a reactor-exchanger or of an exchanger subjected to a use that induces phenomena that may degrade the surface finish of the equipment.

Whatever the machining method used for the manufacture of millistructured exchangers or reactor-exchangers, the channels obtained are semicircular in cross section in the case of chemical etching (FIG. 3) and are made up of two right angles, or are rectangular in cross section in the case of traditional machining and are made up of four right angles. This plurality of angles is detrimental to the obtaining of a protective coating that is uniform over the entire cross section. This is because phenomena of geometric discontinuity such as corners increase the probability of nonuniform deposits being generated, which will inevitably lead to the initiation of phenomena of degradation of the surface finish of the matrix which the intention is to avoid, such as, for example, the phenomena of corrosion, carbiding or nitriding. The angular channel sections obtained by the chemical etching or traditional machining techniques do not allow the mechanical integrity of such an assembly to be optimized. Specifically, the calculations used to engineer the dimensions of such sections in order to withstand pressure have the effect of increasing the wall thicknesses and bottom thicknesses of the channels, the equipment thus losing its compactness and also losing efficiency in terms of heat transfer.

In addition, the chemical etching imposes limitations in terms of the geometric shapes such that it is not possible to have a channel of a height greater than or equal to its width, and this leads to limitations on the surface area/volume ratio, leading to optimization limitations.

The assembly of the etched plates using diffusion bonding is obtained by applying a high uniaxial stress (typically of the order of 2 MPa to 5 MPa) to the matrix made up of a stack of etched plates and applied by a press at a high temperature during a hold time lasting several hours. Use of this technique is compatible with the manufacture of small sized items of equipment such as, for example, equipment contained within a volume of 400 mm×600 mm. Upward of these dimensions, the force that has to be applied in order to maintain a constant stress becomes too great to be applied by a high temperature press.

Certain manufacturers who use diffusion bonding processes overcome the difficulties of achieving a high stress through the use of an assembly said to be self-assembling. This technique does not allow effective control over the stress applied to the equipment, and can cause channels to become crushed.

Assembly of etched plates using diffusion brazing is obtained by applying a low uniaxial stress (typically of the order of 0.2 MPa) applied by a press or by a self-assembly setup at high temperature and for a hold time of several hours on the matrix made up of the etched plates. Between each of the plates, brazed filler metal is applied using industrial application methods which do not allow perfect control of this application to be guaranteed. This filler metal is intended to diffuse into the matrix during the brazing operations so as to create a mechanical connection between the plates.

In addition, during the temperature hold of the equipment while it is being manufactured, the diffusion of the brazing metal cannot be controlled, and this may lead to brazed joints that are discontinuous and which therefore have the effect of impairing the mechanical integrity of the equipment. By way of example, equipment manufactured according to the diffusing and brazing method and engineered in accordance with ASME section VIII div.1 appendix 13.9 made from HR 120 that we have produced have been unable to withstand the application of a pressure of 840×10⁵ Pa (840 bar) during the burst test. To overcome this degradation, the wall thickness and the geometry of the distribution zone were adapted in order to increase the area of contact between each plate. That had the effect of limiting the surface area/volume ratio, of increasing the pressure drop, and of inducing poor distribution in the channels of the equipment.

In addition, the ASME code section VIII div.1 appendix 13.9 used for engineering this type of brazed equipment does not allow the use of diffusion brazing technology for equipment using fluids containing a lethal gas such as carbon monoxide for example. Thus, equipment assembled by diffusion brazing cannot be used for the production of syngas.

Equipment manufactured by diffusion brazing is ultimately made up of a stack of etched plates between which brazed joints are arranged. As a result, each welding operation performed on the faces of this equipment leads in most cases to the destruction of the brazed joints in the heat affected zone affected by the welding operation. This phenomenon spreads along the brazed joints and in most instances causes the assembly to break apart. To alleviate this problem, it is sometimes proposed that thick reinforcing plates be added at the time of assembly of the brazed matrix so as to offer a framelike support for the welding of the connectors which does not have a brazed joint.

From a process intensification standpoint, the fact that the etched plates are assembled with one another means that the equipment needs to be designed with a two-dimensional approach which limits thermal optimization within the exchanger or reactor-exchanger by forcing designers of this type of equipment to confine themselves to a staged approach to the distribution of the fluids.

From an ecomanufacture standpoint, because all these manufacturing steps are performed by different trades, they are generally carried out by various different subcontractors situated in different geographical locations. This results in lengthy production delays and a great deal of component carriage.

### SUMMARY OF THE INVENTION

The present invention proposes to overcome the disadvantages associated with the present-day manufacturing methods.

### BRIEF DESCRIPTION OF THE FIGURES

FIG. 1 illustrates conventional plates with channels of semicircular cross section or cross section involving right angles generally assembled with one another by diffusion bonding or by diffusion brazing.

FIG. 2 is a flow chart of the manufacture of millistructured reactor-exchangers and/or exchangers in which the etched plates are assembled using diffusion bonding or diffusion brazing.

FIG. 3 is a microphotograph of a millistructured exchanger or reactor-exchanger having channels that are semicircular in cross section that are obtained by chemical etching.

FIG. 4 is a microphotograph of a millistructured exchanger or reactor-exchanger having channels that are circular in cross section that are obtained by an additive manufacturing method according to the invention.

FIG. 5 is a flow chart of the additive manufacturing method according to an aspect of the invention for production of an exchanger-reactor or exchanger.

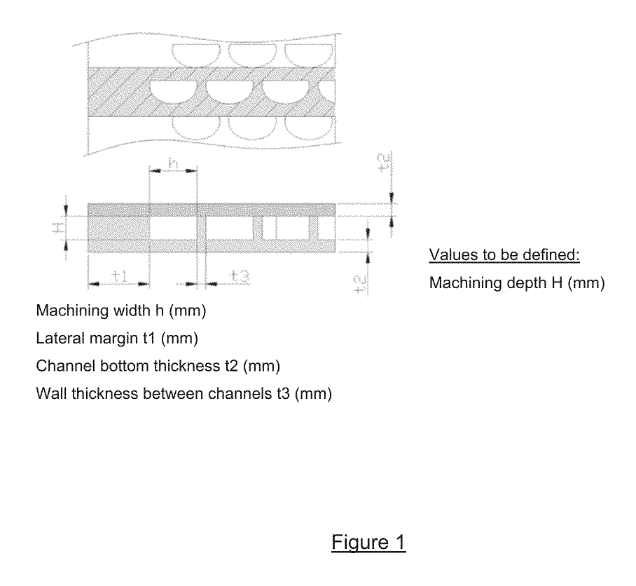

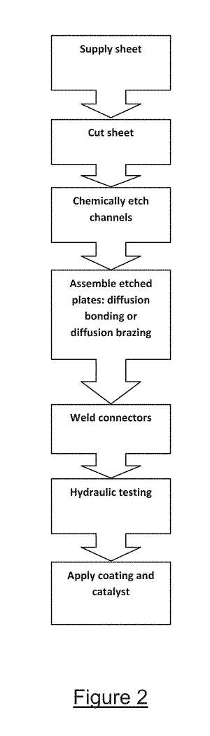

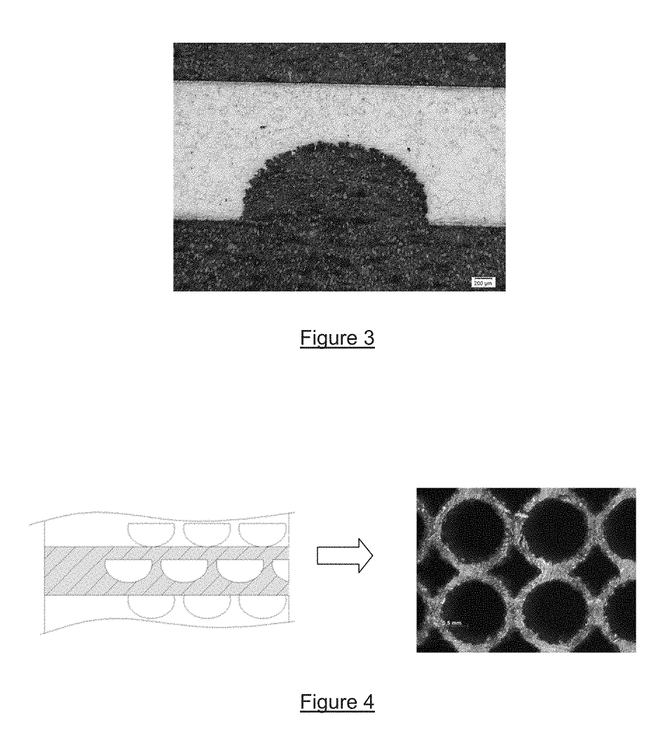

### DETAILED DESCRIPTION OF THE INVENTION

A solution of the present invention is an exchanger-reactor or exchanger comprising at least 3 stages with, on each stage, at least one millimeter-scale channels zone encouraging exchanges of heat and at least one distribution zone upstream and/or downstream of the millimeter-scale channels zone, characterized in that said exchanger-reactor or exchanger is a component that has no assembly interfaces between the various stages.

Depending on the circumstances, the exchanger-reactor or exchanger according to the invention may exhibit one or more of the following features:
the cross sections of the millimeter-scale channels are circular in shape;
said exchanger-reactor is a catalytic exchanger-reactor and comprises:
   at least a first stage comprising at least a distribution zone and at least one millimeter-scale channels zone for circulating a gaseous stream at a temperature greater than 700° C. so that it supplies some of the heat necessary to the catalytic reaction;
   at least a second stage comprising at least a distribution zone and at least one millimeter-scale channels zone for circulating a gaseous stream reagents in the lengthwise direction of the millimeter-scale channels covered with catalyst in order to cause the gaseous stream to react;
   at least a third stage comprising at least a distribution zone and at least one millimeter-scale channels zone for circulating the gaseous stream produced on the second plate so that it supplies some of the heat necessary to the catalytic reaction; with, on the second and the third plate, a system so that the gaseous stream produced can circulate from the second to the third plate.

Another subject of the present invention is the use of an additive manufacturing method for the manufacture of a compact catalytic reactor comprising at least 3 stages with, on each stage, at least one millimeter-scale channels zone encouraging exchanges of heat and at least one distribution zone upstream and/or downstream of the millimeter-scale channels zone.

For preference, the additive manufacturing method will allow the manufacture of an exchanger-reactor or exchanger according to the invention.

An equivalent diameter means an equivalent hydraulic diameter.

As a preference, the additive manufacturing method uses:
as base material, at least one micrometer-scale metallic powder, and/or
at least a laser as an energy source.

Specifically, the additive manufacturing method may employ micrometer-scale metallic powders which are melted by one or more lasers in order to manufacture finished items of complex three-dimensional shapes. The item is built up layer by layer, the layers are of the order of 50 μm, according to the precision for the desired shapes and the desired deposition rate. The metal that is to be melted may be supplied either as a bed of powder or by a spray nozzle. The lasers used for locally melting the powder are either YAG, fiber or CO₂ lasers and the melting of the powders is performed under an inert gas (argon, helium, etc.). The present invention is not confined to a single additive manufacturing technique but applies to all known techniques.

Unlike the traditional machining or chemical etching techniques, the additive manufacturing method makes it possible to create channels of cylindrical cross section which offer the following advantages (FIG. 4):

(i)—better ability to withstand pressure and thus allow a significant reduction in channel wall thickness, and

(ii)—of allowing the use of pressure equipment design rules that do not require a burst test to be carried out in order to prove the effectiveness of the design as is required by section VIII div.1 appendix 13.9 of the ASME code.

Specifically, the design of an exchanger or of a reactor-exchanger produced by additive manufacturing, making it possible to create channels of cylindrical cross section, relies on the “usual” pressure equipment design rules that apply to the dimensioning of the channels, distributors and collectors of cylindrical cross sections that make up the millistructured reactor-exchanger or exchanger.

Additive manufacturing techniques ultimately make it possible to obtain items said to be “solid” which unlike assembly techniques such as diffusion brazing or diffusion bonding, have no assembly interfaces between each etched plate. This property goes towards improving the mechanical integrity of the apparatus by eliminating, by construction, the presence of lines of weakness and by thereby eliminating a source of potential failure.

Obtaining solid components by additive manufacture and eliminating diffusion brazing or diffusion bonding interfaces makes it possible to consider numerous design possibilities without being confined to wall geometries designed to limit the impact of potential assembly defects such as discontinuities in the brazed joints or in the diffusion-bonded interfaces.

Additive manufacture makes it possible to create shapes that are inconceivable using traditional manufacturing methods and thus the manufacture of the connectors for the millistructured reactor-exchangers or exchangers can be done in continuity with the manufacture of the body of the apparatus. This then makes it possible not to have to perform the operation of welding the connectors to the body, thereby making it possible to eliminate a source of impairment to the structural integrity of the equipment.

Control over the geometry of the channels using additive manufacture allows the creation of channels of circular cross section which, aside from the good pressure integrity that this shape brings with it, also makes it possible to have a channel shape that is optimal for the deposition of protective coatings and catalytic coatings which are thus uniform along the entire length of the channels.

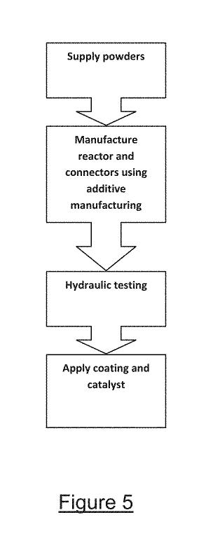

By using this additive manufacturing technology, the gain in productivity aspect is also permitted through the reduction in the number of manufacturing steps. Specifically, the steps of creating a reactor using additive manufacture drop from seven to four (FIG. 5). The critical steps, those that may cause the complete apparatus or the plates that make up the reactor to be scrapped, of which there were four when using the conventional manufacturing technique by assembling chemically etched plates, drop to two with the adoption of additive manufacture. Thus, the only steps to remain are the additive manufacturing step and the step of applying coatings and catalysts.

By way of example, a reactor-exchanger according to the invention can be used for the production of syngas. Further, an exchanger according to the invention can be used in an oxy-combustion process for preheating oxygen.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10 (canceled)

11. An exchanger-reactor or exchanger comprising at least 3 stages with, on each stage, at least one millimeter-scale channels zone encouraging exchanges of heat and at least one distribution zone upstream and/or downstream of the millimeter-scale channels zone, characterized in that said exchanger-reactor or exchanger is a component that has no assembly interfaces between the various stages.

12. The exchanger-reactor or exchanger of claim 11, wherein the cross sections of the millimeter-scale channels are circular in shape.

13. The exchanger-reactor of claim 11, wherein said exchanger-reactor is a catalytic exchanger-reactor and comprises:
at least a first stage comprising at least a distribution zone;
at least a millimeter-scale channels zone for circulating a gaseous stream at a temperature at least greater than 700° C. so that it supplies some of the heat necessary for the catalytic reaction;
at least a second stage comprising at least a distribution zone and at least a millimeter-scale channels zone for circulating a gaseous stream reagents in the lengthwise direction of the millimeter-scale channels covered with catalyst in order to cause the gaseous stream to react;
at least a third stage comprising at least a distribution zone and at least a millimeter-scale channels zone for circulating the gaseous stream produced on the second plate so that it supplies some of the heat necessary for the catalytic reaction; with, on the second and the third plate, a system so that the gaseous stream produced can circulate from the second to the third plate.

14. The exchanger or exchanger-reactor of claim 11 manufactured by an additive manufacturing method.

15. The exchanger or exchanger-reactor of claim 14, wherein the additive manufacturing method uses, as base material, at least one micrometer-scale metallic powder.

16. The exchanger or exchanger-reactor of claim 14, wherein the additive manufacturing method is used for the manufacture of connectors of the exchanger-reactor or exchanger.

17. The exchanger or exchanger-reactor of claim 14, wherein the additive manufacturing method uses, as energy source, at least one laser.
